(19) United States
(12) Patent Application Publication
(10) Pub. No.: US 2024/0025046 A1
(43) Pub. Date: Jan. 25, 2024

(54) ABNORMALITY DETECTION APPARATUS, ABNORMALITY DETECTION METHOD, AND PROGRAM

(71) Applicant: NEC Corporation, Tokyo (JP)

(72) Inventor: Hiroyoshi Yamane, Tokyo (JP)

(73) Assignee: NEC Corporation, Tokyo (JP)

(21) Appl. No.: 18/222,826

(22) Filed: Jul. 17, 2023

(30) Foreign Application Priority Data
Jul. 22, 2022 (JP) 2022-117369

(51) Int. Cl. B25J 9/16

(52) U.S. Cl. CPC B25J 9/1674; B25J 9/1671; B25J 9/1697

(57) ABSTRACT

An abnormality detection apparatus acquires an operation plan of a robot and a real video. The real video is generated by a camera capturing the robot operating according to the operation plan. The abnormality detection apparatus generates a simulation video that is a video of the robot simulated using the operation plan. The abnormality detection apparatus determines whether or not there is an abnormality in the robot by comparing the simulation video with the real video.

### INCORPORATION BY REFERENCE

This application is based upon and claims the benefit of priority from Japanese patent application No. 2022-117369, filed on Jul. 22, 2022, the disclosure of which is incorporated herein in its entirety by reference.

### TECHNICAL FIELD

The present disclosure relates to abnormality detection apparatus, an abnormality detection method, and a program.

### BACKGROUND ART

Techniques for monitoring operations of robots are under development. For example, Patent Literature 1 discloses a technique to determine whether or not there is an abnormality in a robot arm by comparing an operation range of the robot arm in an image of the robot arm operated in a normal state captured in advance and an operation range of the robot arm in an image of the robot arm during operation.
Patent Literature 1: Japanese Unexamined Patent Application Publication No. 2012-187641

In order to introduce the technique of Patent Literature 1, an operation of the robot arm in the normal state must be imaged in advance before the operation of the robot arm is started. An example object of the present disclosure is to disclose a new technique for detecting an abnormality in a robot.

### SUMMARY

In an example aspect, an abnormality detection apparatus according to the present disclosure comprises: at least one memory that is configured to store instructions; and at least one processor.

The at least one processor is configured to execute the instructions to: acquire an operation plan of a robot and a real video generated by a camera, the real video being generated by capturing the robot operating according to the operation plan; generate a simulation video, which is a video of the robot simulated using the operation plan; and determine whether or not there is an abnormality in the robot by comparing the simulation video with the real video.

In another example object, an abnormality detection method according to the present disclosure is executed by a computer. The abnormality detection method comprises: acquiring an operation plan of a robot and a real video generated by a camera, the real video being generated by capturing the robot operating according to the operation plan; generating a simulation video, which is a video of the robot simulated using the operation plan; and determining whether or not there is an abnormality in the robot by comparing the simulation video with the real video.

In another example aspect, a program according to the present disclosure causes a computer to execute the abnormality detection method according to the present disclosure.

According to the present disclosure, a new technique for detecting an abnormality in a robot is provided.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 shows an example of an overview of an operation of an abnormality detection apparatus according to an example embodiment;

FIG. 2 is a block diagram showing an example of a functional configuration of the abnormality detection apparatus;

FIG. 3 is a block diagram showing an example of a hardware configuration of a computer for implementing the abnormality detection apparatus;

FIG. 4 is a flowchart showing an example of a flow of processing executed by the abnormality detection apparatus;

FIG. 5 shows an example of an operation plan;

FIG. 6 shows an example of a case in which a camera suitable for capturing a robot changes depending on a position of the robot;

FIG. 7 shows an example of a case in which a camera suitable for capturing a robot 10 changes depending on the position of the robot;

FIG. 8 shows an example of camera plan information;

FIG. 9 shows an example of a case in which a real video is divided for each predetermined time length; and

FIG. 10 shows an example of a case in which the real video is divided for each operation of the robot.

### EXAMPLE EMBODIMENT

An example embodiment of the present disclosure is described in detail below with reference to the drawings. In each drawing, the same or corresponding elements are denoted by the same signs, and repeated descriptions are omitted as necessary for clarity. Unless otherwise explained, predetermined values such as previously defined values and thresholds are stored in advance in a storage device or the like accessible from an apparatus using the values. Furthermore, unless otherwise explained, a storage unit is composed of one or more specified number of storage devices.

### Overview

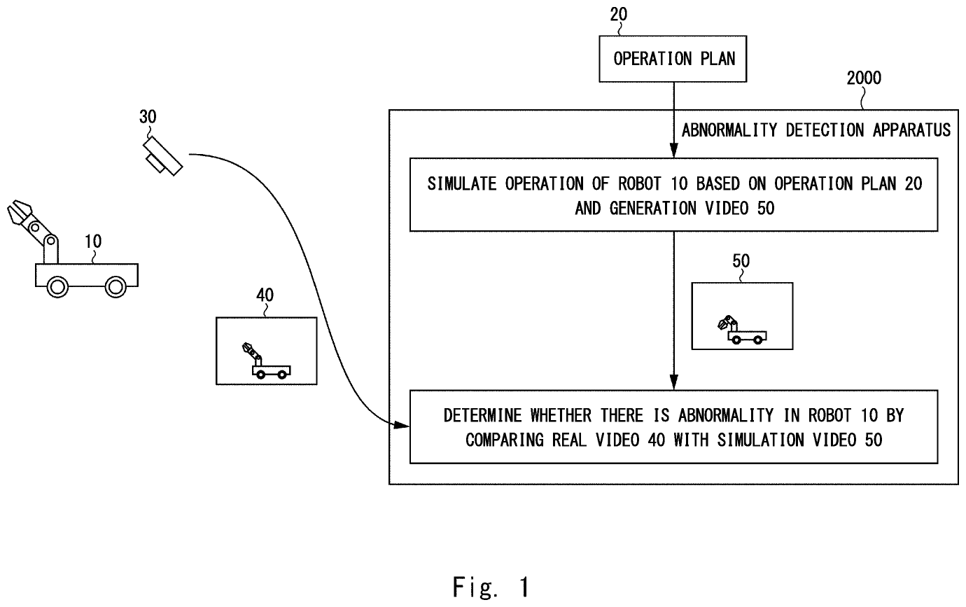

FIG. 1 shows an example of an overview of an abnormality detection apparatus 2000 according to an example embodiment. Here, FIG. 1 is a diagram to facilitate understanding of the overview of the abnormality detection apparatus 2000, and the operation of the abnormality detection apparatus 2000 is not limited to that shown in FIG. 1.

The abnormality detection apparatus 2000 detects an abnormality in the robot 10 operating based on an operation plan 20 using two kinds of videos, a real video 40 and a simulation video 50. The real video 40 is generated by capturing the robot 10 by an actual camera 30. On the other hand, the simulation video 50 is a video of the robot 10 simulated using the operation plan 20.

The robot 10 is configured to perform one or more operations based on the operation plan 20. The operation plan 20 shows one or more matters regarding the time when the robot 10 performs an operation and what operation the robot 10 performs. In other words, the operation plan 20 shows one or more associations between a time and an operation to be performed by the robot 10 at that time. At each of one or more times shown by the operation plan 20, the robot 10 operating based on the operation plan 20 performs an operation associated with that time.

The robot 10 can be used in any place, such as a factory or warehouse. Hereinafter, the place where the robot 10 is used will be referred to as a “target facility”. The target facility may be an indoor place or an outdoor place.

The target facility has a camera 30 that can capture the robot 10. The camera 30 captures the robot 10 and generates the real video 40 obtained by capturing the robot 10.

The camera 30 may be a camera with a fixed capturing range (such a camera is hereinafter referred to as a fixed camera) or a camera with a variable capturing range (such a camera is hereinafter referred to as a non-fixed camera). A fixed camera is, for example, a camera that is mounted at a specific position in the target facility, such as a wall or ceiling, and has a fixed angle of view. A non-fixed camera is, for example, a camera that is mounted at a specific position in the target facility and whose angle of view can be changed (e.g., PTZ cameras). Alternatively, for example, a non-fixed camera may be a camera that is mounted on a moving object such as a security guard or a drone.

The abnormality detection apparatus 2000 generates the simulation video 50 using the operation plan 20. The simulation video 50 is a video that is predicted to be generated when the robot 10 operates based on the operation plan 20 without an abnormality and operations of the robot 10 are captured by the camera 30. It is noted that, in the simulation performed by the abnormality detection apparatus 2000, only the operation of the robot 10 needs to be simulated and the background does not necessarily have to be simulated.

The abnormality detection apparatus 2000 determines whether or not there is an abnormality in the robot 10 by comparing the real video 40 generated by the camera 30 with the simulation video 50 generated through the simulation. Here, the “abnormality in the robot 10” means that the state of the robot 10 is different from the state thereof when it operates according to the operation plan 20.

Here, if the robot 10 operates according to the operation plan 20, the degree of similarity between the real video 40 and the simulation video 50 is predicted to be high. On the other hand, if the robot 10 operates not according to the operation plan 20, the degree of similarity between the real video 40 and the simulation video 50 is predicted to be low.

Thus, the abnormality detection apparatus 2000 computes the degree of similarity between the real video 40 and the simulation video 50, and determines whether or not there is an abnormality in the robot 10 based on the degree of similarity. For example, when the degree of similarity between the real video 40 and the simulation video 50 in a certain period of time is less than or equal to a predetermined threshold, an abnormality in the robot 10 is detected at least for that period of time.

### <Example of Advantageous Effect>

According to the abnormality detection apparatus 2000 of this example embodiment, it is determined whether or not there is an abnormality in the robot 10 by comparing the real video 40 obtained by actually capturing the robot 10 that is following the operation plan 20 with the simulation video 50 obtained by simulating the operation of the robot 10 using the operation plan 20. In this way, according to the abnormality detection apparatus 2000, a new technique for detecting an abnormality in the robot is provided.

Moreover, detecting an abnormality in the robot 10 using the simulation video 50 has the following advantages. First, in the technique disclosed in Patent Literature 1, an operation of the robot in a normal state must be captured by a camera in advance. This increases a workload when the robot is introduced. On the other hand, when the abnormality detection apparatus 2000 is used, it is unnecessary to image an operation of the robot 10 in a normal state by using a camera. Therefore, a workload is smaller when the robot 10 is introduced compared with that with the technique of Patent Literature 1.

In the case of a robot capable of complex operations (e.g., robot with many moving parts), the types of operations that the robot can perform can be enormous. In such a case, the introduction of the technique of Patent Literature 1 requires a camera to capture all the operations the robot can perform while the robot is guaranteed to be in a normal state (e.g., before the start of the operation of the robot). This task is expected to take an enormous amount of time. Therefore, it is presumed to be difficult to introduce the technique of Patent Literature 1 when dealing with robots that can perform complex operations.

On the other hand, the introduction of the abnormality detection apparatus 2000 does not require such an enormous amount of time. In order to use the abnormality detection apparatus 2000, firstly it is not necessary to actually operate the robot 10 and capture it in a normal state. In addition, regarding the simulation, it is only necessary to simulate the operations actually performed by the robot 10 (operations indicated by the operation plan 20), and it is not necessary to simulate all the operations that the robot 10 can perform. For this reason, the time required for the simulation will not become enormous. Therefore, in the abnormality detection apparatus 2000, even a robot capable of complex operations can be a target in which an abnormality is to be detected.

The abnormality detection apparatus 2000 according to this example embodiment will be described in more detail below.

### <Example of Functional Configuration>

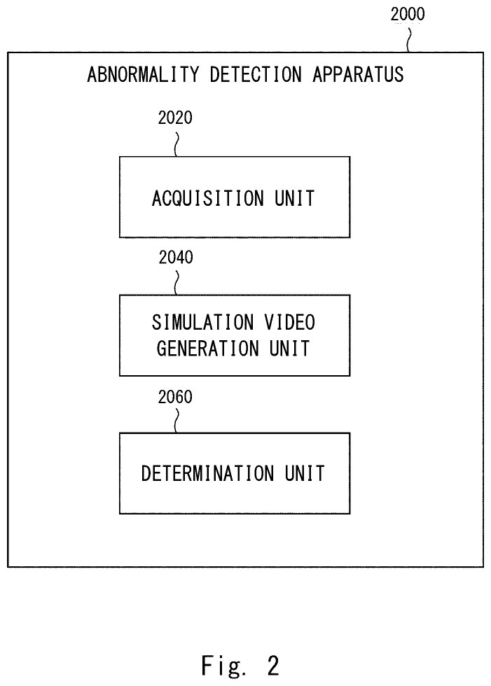

FIG. 2 is a block diagram showing an example of a functional configuration of the abnormality detection apparatus 2000 according to the example embodiment. The abnormality detection apparatus 2000 has an acquisition unit 2020, a simulation video generation unit 2040, and a determination unit 2060. The acquisition unit 2020 acquires the operation plan 20 and the real video 40. The simulation video generation unit 2040 generates the simulation video 50 using the operation plan 20. The determination unit 2060 determines whether or not there is an abnormality in the robot 10 by comparing the real video 40 with the simulation video 50.

### <Example of Hardware Configuration>

Each of the functional components of the abnormality detection apparatus 2000 may be implemented by hardware implementing each functional component (e.g., hardwired electronic circuit, etc.) or by a combination of hardware and software (e.g., a combination of an electronic circuit and a program controlling it, etc.). The case where each of the functional components of the abnormality detection apparatus 2000 is implemented by a combination of hardware and software will be further described below.

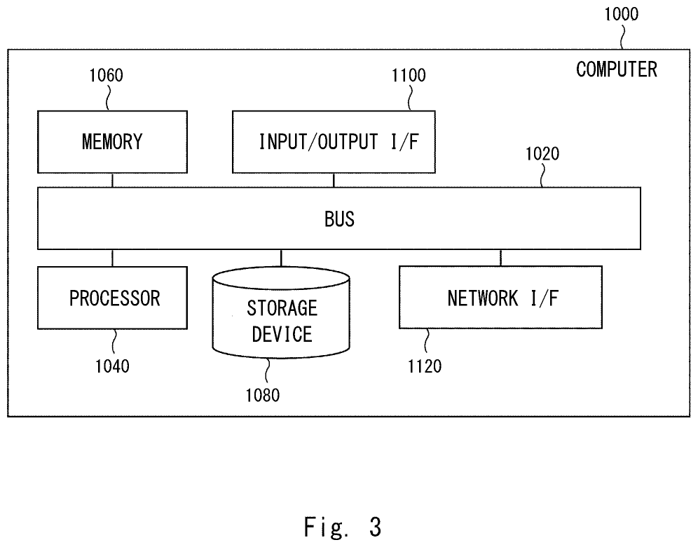

FIG. 3 is a block diagram showing an example of a hardware configuration of a computer 1000 for implementing the abnormality detection apparatus 2000. The computer 1000 is any computer. For example, the computer 1000 is a stationary computer such as a PC (Personal Computer) or a server machine. Alternatively, for example, the computer 1000 is a portable computer such as a smartphone or a tablet terminal. Further alternatively, for example, the computer 1000 is an integrated circuit such as a System on Chip (SoC). The computer 1000 may be a special purpose computer designed to implement the abnormality detection apparatus 2000 or a general-purpose computer.

For example, each function of the abnormality detection apparatus 2000 is implemented by the computer 1000 installing a predetermined application thereto. The above application includes a program for implementing each functional component of the abnormality detection apparatus 2000. The method of acquiring the above program may be any method. For example, the program can be acquired from a storage medium (such as a DVD disc or USB memory) in which the program is stored. In addition, the program can be acquired, for example, by downloading the program from a server apparatus managing a storage device in which the program is stored.

The computer 1000 has a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processors 1040 and the like to each other is not limited to bus connection.

The processor 1040 is one of various processors such as CPU (Central Processing Unit), GPU (Graphics Processing Unit), FPGA (Field-Programmable Gate Array), and DSP (Digital Signal Processor). The memory 1060 is a primary storage device implemented using RAM (Random Access Memory) or the like. The storage device 1080 is a secondary storage device implemented using a hard disk, SSD (Solid State Drive), memory card, ROM (Read Only Memory), or the like.

The input/output interface 1100 is an interface for connecting the computer 1000 to an input/output device. For example, an input device such as a keyboard and an output device such as a display device are connected to the input/output interface 1100.

The network interface 1120 is for connecting the computer 1000 to a network. This network may be a Local Area Network (LAN) or a Wide Area Network (WAN).

The storage device 1080 stores programs (programs for implementing the applications described above) for implementing respective functional components of the abnormality detection apparatus 2000. The processor 1040 reads these programs into the memory 1060 and executes them to implement the respective functional components of the abnormality detection apparatus 2000.

The abnormality detection apparatus 2000 may be implemented by one computer 1000 or by a plurality of the computers 1000. In the latter case, the configuration of each computer 1000 need not be identical and instead may be different from each other.

### <Flow of Processing>

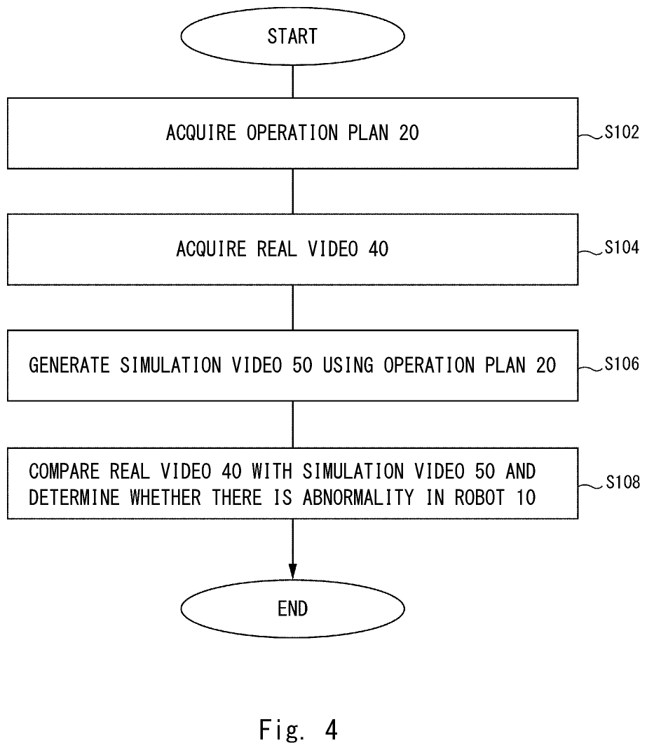

FIG. 4 is a flowchart showing an example of a flow of processing executed by the abnormality detection apparatus 2000 according to the example embodiment. The acquisition unit 2020 acquires the operation plan 20 (S102). The acquisition unit 2020 acquires the real video 40 (S104). The simulation video generation unit 2040 generates the simulation video 50 using the operation plan 20 (S106). The determination unit 2060 determines whether or not there is an abnormality in the robot 10 using the real video 40 and the simulation video 50 (S108).

Here, the flow of processing executed by the abnormality detection apparatus 2000 is not limited to the flow shown in FIG. 1. For example, an order of the execution of S102, S104, and S106 can be any order insofar as the acquisition of the operation plan 20 is done before the generation of the simulation video 50 (i.e., as long as S102 precedes S106).

### <Acquisition of Operation Plan 20: S102>

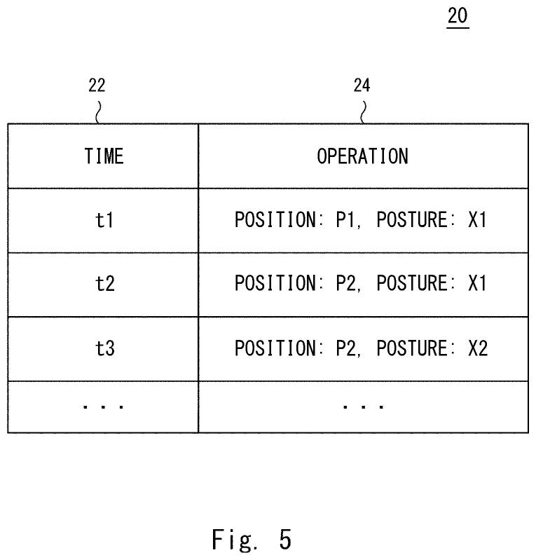

The acquisition unit 2020 acquires the operation plan 20 (S102). As described above, the operation plan 20 shows, for each of one or more times, an association between the time and the operation to be performed by the robot 10 at that time. FIG. 5 shows the operation plan 20. In FIG. 5, the operation plan 20 shows the association between times 22 and operations 24.

Each of the times 22 shows information that can identify the time at which a specific operation should be performed by the robot 10. The time 22 may indicate a relative time with a specific time as a reference time (e.g., time 0), such as a first time shown in the operation plan 20, or it may indicate an absolute time that is an actual date and time.

The operation 24 indicates information that can identify the operation to be performed by the robot 10. The operation 24, for example, indicates a position and a posture of the robot 10. A plurality of pairs of the time 22 and the operation 24 can indicate an operation of the robot 10 by showing changes in the position and posture of the robot 10. The posture of the robot 10 is determined, for example, by posture parameters (such as an angle about each of the three-dimensional rotation axes) of the parts of the robot 10 that can be moved. When there is a plurality of parts that can be moved, the operation 24 indicates, for example, posture parameters for each of the one or more parts whose postures need to be changed. Note that when the position of the robot 10 is fixed, the operation 24 need not indicate the position of the robot 10.

In addition, for example, the operation 24 indicates the operation to be performed by the robot 10 in a manner that can be interpreted by a control computer controlling the operations of the robot 10. The control computer may be provided inside the robot 10 or outside the robot 10. For example, in this case, the operation 24 indicates a command to cause the robot 10 to perform a specific operation. Also, when it is necessary to specify an argument in the command, the operation 24 indicates a combination of the command and the argument.

The method for the acquisition unit 2020 to acquire the operation plan 20 may be any method. For example, the operation plan 20 is stored in advance in a storage unit accessible from the abnormality detection apparatus 2000. In this case, the acquisition unit 2020 accesses this storage unit to acquire the operation plan 20. The storage unit may be provided inside the robot 10 or outside the robot 10. In addition, for example, the acquisition unit 2020 acquires the operation plan 20 by receiving the operation plan 20 transmitted from another apparatus. The other apparatus may be the robot 10 or something other than the robot 10.

Here, the operations performed by the robot 10 may be shown collectively in one operation plan 20 or separated into a plurality of operation plans 20. In the latter case, the acquisition unit 2020 may acquire these plurality of operation plans 20 all at once or at different timings.

### <Acquisition of Real Video 40: S104>

The acquisition unit 2020 acquires the real video 40 (S104). There are various methods for the acquisition unit 2020 to acquire the real video 40. For example, the real video 40 is stored in advance in the storage unit accessible from the abnormality detection apparatus 2000. In this case, the acquisition unit 2020 accesses this storage unit to acquire the real video 40. This storage unit may be provided inside the camera 30 or outside the camera 30. In addition, for example, the acquisition unit 2020 acquires the real video 40 by receiving the real video 40 transmitted from another apparatus. The other apparatus may be the camera 30 or an apparatus other than the camera 30.

A series of operations performed by the robot 10 may be captured on a single real video 40 or may be captured separately on a plurality of the real videos 40. In the latter case, the acquisition unit 2020 may acquire the plurality of real videos 40 at once or at different timings.

Moreover, the acquisition unit 2020 may acquire the real video 40 by sequentially acquiring a plurality of video frames constituting the real video 40. For example, the camera 30 is configured to transmit the video frame to the abnormality detection apparatus 2000 each time a video frame is generated. In this case, the acquisition unit 2020 can acquire the real video 40 by acquiring the video frame transmitted from the camera 30 and generating the real video 40 from a plurality of the video frames inside the abnormality detection apparatus 2000. The acquisition unit 2020 may generate one real video 40 or the plurality of real video 40 from the plurality of video frames transmitted from the camera 30. In the latter case, for example, the acquisition unit 2020 generates the real video 40 from the video frames every time it acquires a predetermined number of video frames. In this way, the real video 40 is generated every predetermined time length such as 30 seconds or 1 minute.

<<Case where a Plurality of Cameras 30 are Provided>>

A plurality of the cameras 30 may be provided in the target facility. When the robot 10 moves in the target facility, a suitable position for capturing the operations of the robot 10 depends on the position and the posture of the robot 10. For this reason, it is preferable to provide the plurality of cameras 30 in the target facility and switch the camera 30 used for detecting an abnormality in the robot according to the position and the posture of the robot 10.

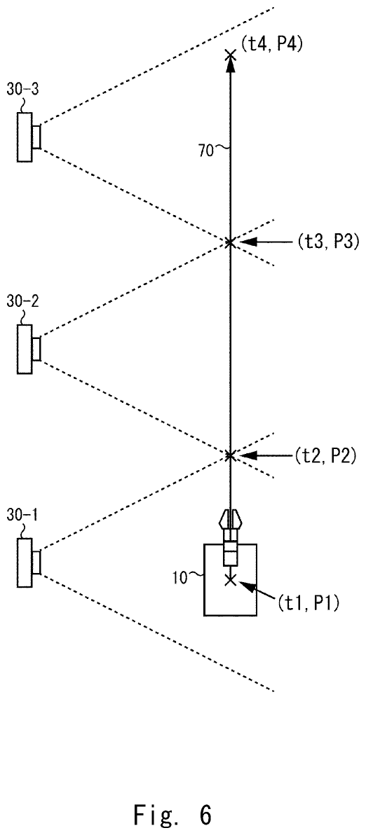

FIG. 6 shows an example of a case where the camera 30 suitable for capturing the robot 10 changes according to the position of the robot 10. In FIG. 6, three cameras 30, the camera 30-1 to the camera 30-3, are provided.

The robot 10 moves according to the arrow 70. The positions of the robot 10 at times t1, t2, t3, and t4 are positions P1, P2, P3, and P4, respectively.

Here, the camera 30-1 is most suitable for capturing the robot 10 located in the range of the positions P1 to P2. Also, the camera 30-2 is most suitable for capturing the robot 10 located in the range of the positions P2 to P3. Likewise, the camera 30-3 is most suitable for capturing the robot 10 located in the range of the positions P3 to P4. Thus, the cameras 30 suitable for capturing the robot 10 can change depending on the position of the robot 10.

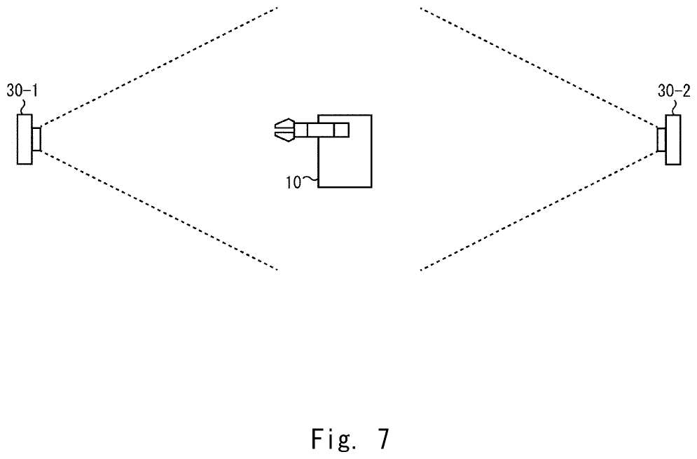

FIG. 7 shows an example of a case where the camera 30 suitable for capturing the robot 10 changes depending on the posture of the robot 10. In FIG. 7, two cameras 30, the camera 30-1 and the camera 30-2, are provided.

The camera 30-1 is most suitable for capturing the robot 10 while the robot performs an operation facing left (e.g., operation of extending an arm to the left to take an object, etc.) in FIG. 7. On the other hand, the camera 30-2 is the most suitable for capturing the robot 10 while the robot 10 performs an operation facing right (e.g., operation of extending an arm to the right to take an object, etc.) in FIG. 7. Thus, the cameras 30 suitable for capturing the robot 10 can also change depending on the posture of the robot 10.

Therefore, when the plurality of cameras 30 are provided, for example, the acquisition unit 2020 determines the camera 30 that should be used from among the plurality of cameras 30. The determined camera is hereinafter referred to as a target camera. Next, the acquisition unit 2020 acquires the real video 40 from the target camera.

The camera 30 that should be used by the abnormality detection apparatus 2000 can change over time. Therefore, the target camera is determined in association with a period during which the target camera should be used.

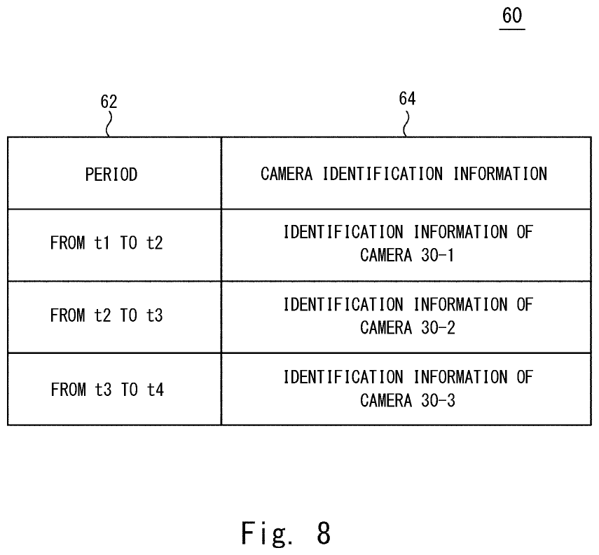

There are various methods to determine the correspondence between the period and the target camera. For example, the acquisition unit 2020 determines the target camera for each period using information in which the period is associated with identification information about the target camera (this information is hereinafter referred to as camera plan information). FIG. 8 shows an example of the camera plan information. In camera plan information 60, each of periods 62 is associated with camera identification information 64. Each of the periods 62 indicates a period during which the corresponding target camera should be used. The camera identification information 64 indicates the identification information about the target camera.

FIG. 8 shows the camera plan information 60 corresponding to the case of FIG. 6. For example, as described above, in the case of FIG. 6, the camera 30-1 is most suitable for capturing the robot 10 located in the range of the positions P1 to P2. Further, the period in which the position of the robot 10 is between P1 and P2 is from the time t1 to t2. Therefore, in a first record of the camera plan information 60 in FIG. 8, the identification information about the camera 30-1 is shown in the camera identification information 64 corresponding to the period 62 from the time t1 to t2.

The acquisition unit 2020 uses the camera plan information 60 to acquire the real video 40 corresponding to each of the plurality of periods. Specifically, for each of the plurality of periods 62 indicated in the camera plan information 60, the acquisition unit 2020 determines the camera identification information 64 corresponding to the period 62. Next, the acquisition unit 2020 acquires the real video 40 generated by the camera 30 that is determined by the determined camera identification information 64.

The camera plan information 60 may be manually generated or may be generated by a computer based on the operation plan 20. In the latter case, the computer generating the camera plan information 60 may be the abnormality detection apparatus 2000 or an apparatus other than the abnormality detection apparatus 2000.

When the camera plan information 60 is manually created or generated by an apparatus other than the abnormality detection apparatus 2000, the camera plan information 60 is stored in advance in a storage unit accessible from the abnormality detection apparatus 2000. On the other hand, when the camera plan information 60 is generated by the abnormality detection apparatus 2000, the abnormality detection apparatus 2000 uses the acquired operation plan 20 to generate the camera plan information 60. In the following description, it is assumed that the camera plan information 60 is generated by the abnormality detection apparatus 2000. The functional component of the abnormality detection apparatus 2000 that generates the camera plan information 60 is referred to as a camera plan information generation unit (not illustrated).

The acquisition unit 2020 uses the operation plan 20 to determine time changes in the position, the posture, or both of the robot 10. Furthermore, for each of the plurality of times included in the period from the first time to the last time (hereafter such a period is referred to as an operating period of the robot 10) shown in the operation plan 20, the acquisition unit 2020 determines the camera suitable for capturing the robot 10 at that time as the target camera. For example, the target camera is determined for each of the plurality of times extracted at predetermined intervals from the operation period of the robot 10. In addition, the acquisition unit 2020 determines, as the period corresponding to those target cameras, a set of times among which the target cameras are in common and continuous on a time axis. Through the above processing, for each of the plurality of periods included in the operation period of the robot 10, the correspondence between the period and the target camera, i.e., the camera plan information 60, is generated.

Note that the method for determining the camera 30 most suitable for capturing the robot 10 at a certain time may be any method. For example, at a certain time, the abnormality detection apparatus 2000 determines the camera 30 that includes the robot 10 in its capturing range and is positioned in the direction that a part (e.g., arm) of the robot 10 to be captured is facing as the most suitable camera 30 for capturing the robot 10.

### <Generation of Simulation Video 50: S106>

The simulation video generation unit 2040 generates the simulation video 50 using the operation plan 20 (S106). For example, the simulation video generation unit 2040 generates the simulation video 50 using the operation plan 20 and a three-dimensional model (hereinafter referred to as a virtual robot) of the robot 10 disposed in a virtual three-dimensional space. The data representing the virtual robot is stored in advance in a storage unit accessible from the abnormality detection apparatus 2000.

More specifically, the simulation video generation unit 2040 uses the operation plan 20 to simulate the changes in the position and the posture (i.e., operations) of the robot 10 that are scheduled in a real space using the changes in the position and posture of the virtual robot in the virtual three-dimensional space. Next, the simulation video generation unit 2040 generates the simulation video 50 by virtually capturing the operation of the virtual robot in the virtual three-dimensional space with a virtual camera disposed in a virtual three-dimensional space.

The virtual camera is equivalent to the camera 30 in the real space. The position of the virtual camera in the virtual three-dimensional space and the camera parameters (angle of view, focal length, etc.) are those that reproduce the position of the camera 30 in the real space and the camera parameters in the virtual three-dimensional space, respectively.

Here, the technique used in three-dimensional Computer Graphics (CG) software or the like can be used for the technique to generate a video obtained by virtually capturing a virtual object disposed in a virtual three-dimensional space by a virtual camera disposed in the virtual three-dimensional space.

The virtual robot may be a three-dimensional model in which the robot 10 is reproduced with the granularity necessary to detect an abnormality in the operation of the robot 10, and it may not be a three-dimensional model in which the robot 10 is completely reproduced. For example, in the virtual robot, the shape and size of the robot 10 may be reproduced, and the color and texture of the robot 10 may not be reproduced.

There are various specific methods for simulating, in the virtual three-dimensional space, the operation of the robot 10 in the real space. For example, in the operation plan 20, the operation of the robot 10 is expressed by the posture parameters of the robot 10. In this case, for example, the simulation video generation unit 2040 changes the posture of the virtual robot at the simulation time corresponding to each of the plurality of times shown in the operation plan 20 to the posture specified by the posture parameter corresponding to the time.

In addition, for example, the operation 24 indicates a command representing the operation to be executed by the robot 10. In this case, the simulation video generation unit 2040 changes the posture of the virtual robot by determining the posture change of the virtual robot caused by the execution of the command for the simulation time corresponding to each of the plurality of times indicated by the operation plan 20. The posture change of the robot 10 caused by the execution of the command can be determined by using, for example, simulation software for simulating control of the robot 10.

As described above, the position of the robot 10 may change due to the operation of the robot 10. In this case, the simulation video generation unit 2040 changes, using the operation plan 20, the position of the virtual robot in the virtual three-dimensional space in addition to the posture of the virtual robot.

It is noted that the simulation video generation unit 2040 may further simulate the background of the robot 10 by further using the three-dimensional model of the target facility (hereinafter referred to as a virtual facility). In this case, the simulation video generation unit 2040 simulates the robot 10 and the camera 30 in the target facility in the real space by disposing the virtual robot and the virtual camera in the virtual facility.

<<Case where the Camera 30 is Non-Fixed Camera>>

When the camera 30 is a non-fixed camera, the position of the camera 30 and the camera parameters can change over time. Thus, for example, the simulation video generation unit 2040 acquires information (hereinafter referred to as camera operation information) in which a time, the position of the camera 30 at that time, and the camera parameters are associated with each other. The camera operation information is realized by, for example, a log of the operations of the camera 30. Next, the simulation video generation unit 2040 sets the position of the virtual camera and the camera parameters based on the position of the camera 30 and the camera parameters indicated by the camera operation information for the simulation time corresponding to each of the plurality of times indicated in the camera operation information. As a result, the simulation video can also be generated for a case in which the robot 10 is captured by a PTZ camera, a camera installed in a drone, or the like, whose positions and angles of view change.

<<Case where a Plurality of Cameras 30 are Provided>>

When the plurality of cameras 30 are provided, a virtual camera corresponding to each of these the plurality of cameras 30 is used in a simulation. For example, the simulation video generation unit 2040 selects a specific camera 30 from among the plurality of cameras 30, and generates the simulation video 50 using the virtual camera corresponding to the selected camera 30.

For example, the simulation video generation unit 2040 uses the aforementioned camera plan information 60 to select a virtual camera (above-mentioned target camera) to be used for generating the simulation video 50. The camera plan information 60 associates the period 62 with the target camera, which is the camera 30 that should be used during the period 62. For each of the plurality of periods 62 shown by the camera plan information 60, the simulation video generation unit 2040 generates the simulation video 50 using the virtual camera determined by the camera identification information 64 corresponding to the period 62. The virtual camera determined by the camera identification information 64 is a virtual camera that is a reproduction of the camera 30 determined by the camera identification information 64 is reproduced.

<<Case where a Plurality of Real Videos 40 are Acquired>>

The acquisition unit 2020 may acquire a plurality of the real videos 40 including operations of the robot 10 performed during time periods different from each other. In this case, the simulation video generation unit 2040 preferably generates the simulation video 50 corresponding to each real video 40.

For example, suppose that the acquisition unit 2020 acquires a real video R1 by which the operations of the robot 10 at times t1 to t2 are recorded and a real video R2 by which the operations of the robot 10 at times t2 to t3 are recorded. In this case, the simulation video generation unit 2040 generates a simulation video S1 in which the operations of the robot 10 at times t1 to t2 are simulated and a simulation video S2 in which the operations of the robot 10 at times t2 to t3 are simulated. Next, the real video R1 is compared with the simulation video S1, and the real video R2 is compared with the simulation video S2.

### <Abnormality Detection: S108>

Using the real video 40 and the simulation video 50, the determination unit 2060 determines whether or not there is an abnormality in the robot 10 (S108). Specifically, the determination unit 2060 computes the similarity between the real video 40 and the simulation video 50, and determines whether or not there is an abnormality in the robot 10 based on the computed similarity. For example, the determination unit 2060 determines that there is an abnormality in the robot 10 when the computed similarity is less than or equal to a threshold. On the other hand, if the computed similarity is greater than the threshold, the determination unit 2060 determines that there is no abnormality in the robot 10.

For example, the determination unit 2060 extracts an outer shape of the robot 10 from each video frame of the real video 40 and the simulation video 50 using techniques such as edge detection. Further, for each of the plurality of times, the determination unit 2060 computes the similarity between the outer shape of the robot 10 extracted from the video frame of the real video 40 at that time and an outer shape of the robot 10 extracted from the video frame of the simulation video 50 at that time. Next, the determination unit 2060 computes the similarity between the real video 40 and the simulation video 50 using the similarity between the video frames computed for each time. The similarity between the real video 40 and the simulation video 50 is computed, for example, as a statistical value (such as an average value) of the computed similarity between the outer shapes of the robot 10 of the respective video frames.

In addition, for example, the determination unit 2060 may compute the similarity between the real video 40 and the simulation video 50 using a pre-trained machine learning model. For example, a 3D CNN (Convolutional Neural Network) can be used as the machine learning model. For example, the determination unit 2060 obtains a feature value of each of the real video 40 and the simulation video 50 by inputting each of the real video 40 and the simulation video 50 into the machine learning model, respectively. The determination unit 2060 then computes the similarity between these feature values as the similarity between the real video 40 and the simulation video 50. Here, various well-known techniques can be used to compute the similarity between the feature values.

There is a possibility that the start time of the real video 40 and that of the simulation video 50 do not match. For this reason, it is preferable for the determination unit 2060 to align the real video 40 and the simulation video 50 on the time axis.

Suppose that the time of each operation shown by the operation plan 20 is expressed by absolute time. In this case, the determination unit 2060 removes, from the real video 40, the videos at and before the time of the first operation shown by the operation plan 20. By doing so, the start time of the real video 40 matches that of the simulation video 50. On the other hand, suppose that the time of each operation shown by the operation plan 20 is expressed by relative time with the time of the first operation as a reference time. In this case, the determination unit 2060 determines the absolute time corresponding to the reference time, and removes, from the real video 40, the videos at and before that absolute time. Here, the absolute time when the operation of the robot 10 is started can be obtained from the robot 10 or the control computer that instructs the robot 10 to operate based on the operation plan 20.

When the plurality of real videos 40 are acquired, for example, the determination unit 2060 compares each of the plurality of real videos 40 with the corresponding simulation video 50. For example, when the plurality of cameras are used as described above, the real videos 40 are acquired from the target cameras corresponding to each of the plurality of periods by using the camera plan information 60. Moreover, the simulation video 50 corresponding to each of the real videos 40 is generated by using the camera plan information 60. By comparing the real videos 40 and the simulation videos 50 that correspond each other, the determination unit 2060 determines whether or not there is an abnormality in the robot 10 for each pair of the real video 40 and the simulation video 50.

The determination unit 2060 may divide the real video 40 into a plurality of videos. In this case, the determination unit 2060 compares the plurality of real videos obtained by the division (the divided videos are hereinafter referred to as partial real videos) with the corresponding simulation videos. In this manner, it is determined whether or not there is an abnormality in the robot 10 for each partial real video.

This division of the real video 40 into the plurality of video is particularly effective in a case where the robot 10 operates abnormally only for a short period of time. This is because, in a case where the robot 10 operates abnormally for a short period of time, it is possible that the similarity between the real video 40 and the simulation video 50 is high when all the real videos 40 is compared with the simulation videos 50.

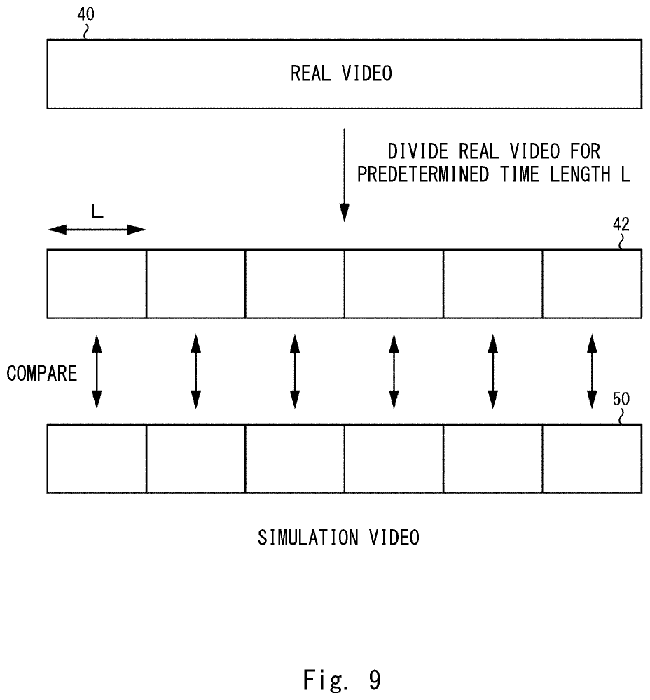

There are various methods for dividing the real video 40 into the plurality of videos. For example, the determination unit 2060 divides the real video 40 into partial real videos for each predetermined time length. FIG. 9 shows an example of a case where the real video 40 is divided for each predetermined time length. In FIG. 9, the real video 40 is divided into partial real videos 42 each of whose length of time is L. The determination unit 2060 compares each of the simulation videos 50 whose length of time is L with the corresponding partial real video 42.

The simulation video generation unit 2040 may generate the simulation video 50 corresponding to the real video 40 or the simulation video 50 corresponding to each partial real video 42. In the former case, the determination unit 2060 divides the simulation video 50 into videos each of whose length of time is L, in a manner similar to the case of the real video 40.

In addition, for example, the determination unit 2060 may divide the real video 40 into a predetermined number of partial real video 42 (not illustrated).

Furthermore, for example, the determination unit 2060 may divide the real video 40 for each operation indicated by the operation plan 20. In this way, whether or not there is an abnormality in the robot 10 is determined for each operation of the robot 10 indicated by the operation plan 20.

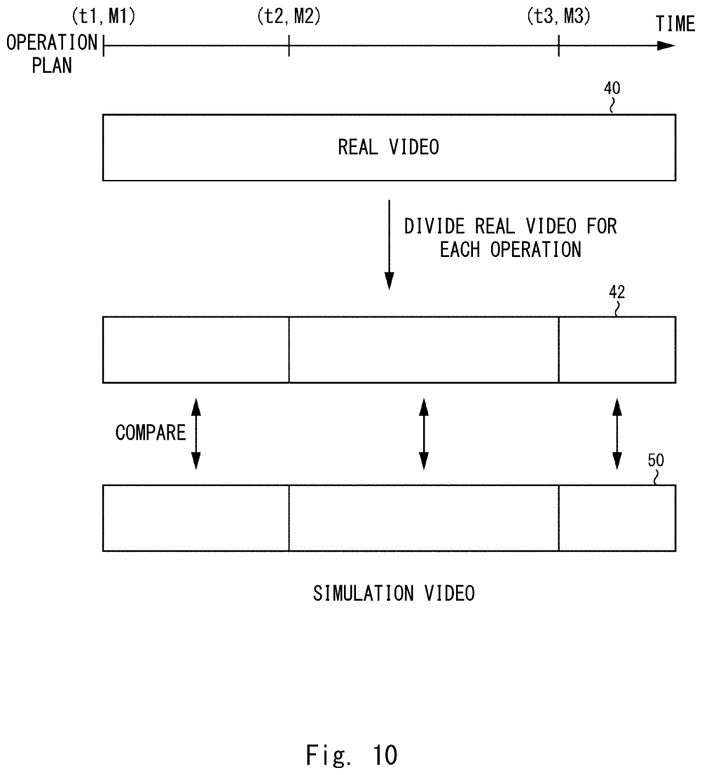

FIG. 10 shows an example of a case where the real video 40 is divided into videos of respective operations of the robot 10. In FIG. 10, the operation plan 20 shows three operations: (time t1, operation M1), (time t2, operation M2), and (time t3, operation M3).

The determination unit 2060 divides the real video 40 into three partial real videos 42: a partial real video 42 from time t1 to t2, a partial real video 42 from time t2 to t3, and a partial real video 42 after time t3. Next, the determination unit 2060 compares the partial real video 42 with the simulation video 50 for each of the three periods: the period from time t1 to t2, the period from time t2 to t3, and the period from time t3.

The determination unit 2060 may further divide the partial real video 42 divided for each operation into a plurality of videos. For example, the partial real video 42 is divided for each predetermined time length or into a predetermined number of videos.

### <Output of Result>

The abnormality detection apparatus 2000 outputs information indicating a result of the processing (such information is hereinafter referred to as output information). For example, the output information indicates whether or not there is an abnormality in the robot 10. When the plurality of real videos 40 are acquired, for example, the output information may indicate whether or not there is an abnormality in the robot 10 for each real video 40. In addition, for example, the output information may include, among the plurality of real videos 40, identification information (e.g., file name) of the real video 40 in which an abnormality in the robot 10 is detected, or the real video 40 itself in which an abnormality in the robot 10 is detected.

When the real video 40 is divided into the plurality of partial real videos 42, for example, the output information indicates whether or not there is an abnormality in the robot 10 for each partial real video 42. In addition, for example, the output information may include, among the plurality of partial real videos 42, identification information (e.g., file name) of the partial real video 42 in which an abnormality in the robot 10 is detected, or the partial real video 42 itself in which an abnormality in the robot 10 is detected.

The output information may indicate information regarding the operations that the robot 10 has been performing when an abnormality is detected (e.g., the posture and commands of the robot 10). The operation that the robot 10 has been performing when an abnormality is detected can be determined based on the correspondence between the real video 40 or the partial real video 42 in which the abnormality is detected and the operation plan 20.

For example, suppose that an abnormality of the robot 10 is detected from the real video 40 or the partial real video 42 between times t1 and t2. In this case, by extracting the operation of the robot 10 performed between times t1 and t2 from the operation plan 20, the abnormality detection apparatus 2000 can determine the operation of the robot 10 that has been performed when the abnormality is detected.

A manner of output of the output information may be any manner. For example, the abnormality detection apparatus 2000 puts the output information into a storage unit. In addition, for example, the abnormality detection apparatus 2000 causes a display device to display the output information. Furthermore, for example, the abnormality detection apparatus 2000 may transmit the output information to other apparatuses. Examples of such other apparatuses include a computer used by an administrator of the target facility or a worker working at the target facility.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the exemplary embodiments disclosed above can be described as, but not limited to, the following supplementary notes.

### (Supplementary Note 1)

An abnormality detection apparatus comprising:
at least one memory that is configured to store instructions; and
at least one processor that is configured to execute the instructions to:
acquire an operation plan of a robot and a real video generated by a camera, the real video being generated by capturing the robot operating according to the operation plan;
generate a simulation video, which is a video of the robot simulated using the operation plan; and
determine whether or not there is an abnormality in the robot by comparing the simulation video with the real video.

### (Supplementary Note 2)

The abnormality detection apparatus according to Supplementary note 1,
wherein the at least one processor is configured to execute the instructions further to:
compute a similarity between the real video and the simulation video; and
determine that there is the abnormality in the robot when the similarity is less than or equal to a threshold.

### (Supplementary Note 3)

The abnormality detection apparatus according to Supplementary note 1,
wherein the operation plan indicates a plurality of associations between a time and an operation to be performed by the robot at that time, and
wherein the at least one processor is configured to execute the instructions further to:
acquire a three-dimensional model of the robot; and
generate, for each of a plurality of times indicated by the operation plan, the simulation video by changing a state of the three-dimensional model at the time to a state based on the operation corresponding to the time.

### (Supplementary Note 4)

The abnormality detection apparatus according to Supplementary note 1,
wherein the at least one processor is configured to execute the instructions further to:
determine, for each of a plurality of periods, a target camera from among a plurality of the cameras, the target camera being a camera that is to acquire the real video in the period;
acquire the real video generated by the target camera; and
generate, for each of the plurality of periods, the simulation video of the robot captured by the target camera in the period.
   (Supplementary note 5)

The abnormality detection apparatus according to Supplementary note 4,
wherein the at least one processor is configured to execute the instructions further to:
acquire camera plan information indicating the target camera for each of the plurality of periods;
acquire, for each of the plurality of periods indicated by the camera plan information, the real video generated by the target camera associated with the period in the camera plan information; and
generate the simulation video of the robot captured by the target camera associated with the period in the camera plan information for each of the plurality of periods indicated by the camera plan information.

### (Supplementary Note 6)

An abnormality detection method executed by a computer comprising:
acquiring an operation plan of a robot and a real video generated by a camera, the real video being generated by capturing the robot operating according to the operation plan;
generating a simulation video, which is a video of the robot simulated using the operation plan; and
determining whether or not there is an abnormality in the robot by comparing the simulation video with the real video.

### (Supplementary Note 7)

The abnormality detection method according to Supplementary note 6, further comprising:
computing a similarity between the real video and the simulation video; and
determining that there is the abnormality in the robot when the similarity is less than or equal to a threshold.

### (Supplementary Note 8)

The abnormality detection method according to Supplementary note 6,
wherein the operation plan indicates a plurality of associations between a time and an operation to be performed by the robot at that time, and
wherein the abnormality detection method further comprises:
acquiring a three-dimensional model of the robot; and
generating, for each of a plurality of times indicated by the operation plan, the simulation video by changing a state of the three-dimensional model at the time to a state based on the operation corresponding to the time.

### (Supplementary Note 9)

The abnormality detection method according to Supplementary note 6, further comprising:
determining, for each of a plurality of periods, a target camera from among a plurality of the cameras, the target camera being a camera that is to acquire the real video in the period;
acquiring the real video generated by the target camera; and
generating, for each of the plurality of periods, the simulation video of the robot captured by the target camera in the period.

### (Supplementary Note 10)

The abnormality detection method according to Supplementary note 9, further comprising:
acquiring camera plan information indicating the target camera for each of the plurality of periods;
acquiring, for each of the plurality of periods indicated by the camera plan information, the real video generated by the target camera associated with the period in the camera plan information; and
generating the simulation video of the robot captured by the target camera associated with the period in the camera plan information for each of the plurality of periods indicated by the camera plan information.

### (Supplementary Note 11)

A non-transitory computer-readable medium storing a program that causes a compute to execute:
acquiring an operation plan of a robot and a real video generated by a camera, the real video being generated by capturing the robot operating according to the operation plan;
generating a simulation video, which is a video of the robot simulated using the operation plan; and
determining whether or not there is an abnormality in the robot by comparing the simulation video with the real video.

### (Supplementary Note 12)

The medium according to Supplementary note 11, wherein the program causes the computer to further execute:
computing a similarity between the real video and the simulation video; and
determining that there is the abnormality in the robot when the similarity is less than or equal to a threshold.

### (Supplementary Note 13)

The medium according to Supplementary note 11,
wherein the operation plan indicates a plurality of associations between a time and an operation to be performed by the robot at that time, and
wherein the program causes the computer to further execute:
acquiring a three-dimensional model of the robot; and
generating, for each of a plurality of times indicated by the operation plan, the simulation video by changing a state of the three-dimensional model at the time to a state based on the operation corresponding to the time.

### (Supplementary Note 14)

The medium according to Supplementary note 11,
wherein the program causes the computer to further execute:
determining, for each of a plurality of periods, a target camera from among a plurality of the cameras, the target camera being a camera that is to acquire the real video in the period;
acquiring the real video generated by the target camera; and
generating, for each of the plurality of periods, the simulation video of the robot captured by the target camera in the period.

### (Supplementary Note 15)

The medium according to Supplementary note 14,
wherein the program causes the computer to further execute:
acquiring camera plan information indicating the target camera for each of the plurality of periods;
acquiring, for each of the plurality of periods indicated by the camera plan information, the real video generated by the target camera associated with the period in the camera plan information; and
generating the simulation video of the robot captured by the target camera associated with the period in the camera plan information for each of the plurality of periods indicated by the camera plan information.

What is claimed is:

1. An abnormality detection apparatus comprising:
at least one memory that is configured to store instructions; and
at least one processor that is configured to execute the instructions to:
acquire an operation plan of a robot and a real video generated by a camera, the real video being generated by capturing the robot operating according to the operation plan;
generate a simulation video, which is a video of the robot simulated using the operation plan; and
determine whether or not there is an abnormality in the robot by comparing the simulation video with the real video.

2. The abnormality detection apparatus according to claim 1,
wherein the at least one processor is configured to execute the instructions further to:
compute a similarity between the real video and the simulation video; and
determine that there is the abnormality in the robot when the similarity is less than or equal to a threshold.

3. The abnormality detection apparatus according to claim 1,
wherein the operation plan indicates a plurality of associations between a time and an operation to be performed by the robot at that time, and
wherein the at least one processor is configured to execute the instructions further to:
acquire a three-dimensional model of the robot; and
generate, for each of a plurality of times indicated by the operation plan, the simulation video by changing a state of the three-dimensional model at the time to a state based on the operation corresponding to the time.

4. The abnormality detection apparatus according to claim 1,
wherein the at least one processor is configured to execute the instructions further to:
determine, for each of a plurality of periods, a target camera from among a plurality of the cameras, the target camera being a camera that is to acquire the real video in the period;
acquire the real video generated by the target camera; and
generate, for each of the plurality of periods, the simulation video of the robot captured by the target camera in the period.

5. The abnormality detection apparatus according to claim 4,
wherein the at least one processor is configured to execute the instructions further to:
acquire camera plan information indicating the target camera for each of the plurality of periods;
acquire, for each of the plurality of periods indicated by the camera plan information, the real video generated by the target camera associated with the period in the camera plan information; and
generate the simulation video of the robot captured by the target camera associated with the period in the camera plan information for each of the plurality of periods indicated by the camera plan information.

6. An abnormality detection method executed by a computer comprising:
acquiring an operation plan of a robot and a real video generated by a camera, the real video being generated by capturing the robot operating according to the operation plan;
generating a simulation video, which is a video of the robot simulated using the operation plan; and
determining whether or not there is an abnormality in the robot by comparing the simulation video with the real video.

7. The abnormality detection method according to claim 6, further comprising:
computing a similarity between the real video and the simulation video; and
determining that there is the abnormality in the robot when the similarity is less than or equal to a threshold.

8. The abnormality detection method according to claim 6,
wherein the operation plan indicates a plurality of associations between a time and an operation to be performed by the robot at that time, and
wherein the abnormality detection method further comprises:
acquiring a three-dimensional model of the robot; and
generating, for each of a plurality of times indicated by the operation plan, the simulation video by changing a state of the three-dimensional model at the time to a state based on the operation corresponding to the time.

9. The abnormality detection method according to claim 6, further comprising:
determining, for each of a plurality of periods, a target camera from among a plurality of the cameras, the target camera being a camera that is to acquire the real video in the period;
acquiring the real video generated by the target camera; and
generating, for each of the plurality of periods, the simulation video of the robot captured by the target camera in the period.

10. The abnormality detection method according to claim 9, further comprising:
acquiring camera plan information indicating the target camera for each of the plurality of periods;
acquiring, for each of the plurality of periods indicated by the camera plan information, the real video generated by the target camera associated with the period in the camera plan information; and
generating the simulation video of the robot captured by the target camera associated with the period in the camera plan information for each of the plurality of periods indicated by the camera plan information.

11. A non-transitory computer-readable medium storing a program that causes a compute to execute:
acquiring an operation plan of a robot and a real video generated by a camera, the real video being generated by capturing the robot operating according to the operation plan;
generating a simulation video, which is a video of the robot simulated using the operation plan; and
determining whether or not there is an abnormality in the robot by comparing the simulation video with the real video.

12. The medium according to claim 11, wherein the program causes the computer to further execute:
computing a similarity between the real video and the simulation video; and
determining that there is the abnormality in the robot when the similarity is less than or equal to a threshold.

13. The medium according to claim 11,
wherein the operation plan indicates a plurality of associations between a time and an operation to be performed by the robot at that time, and
wherein the program causes the computer to further execute:
acquiring a three-dimensional model of the robot; and
generating, for each of a plurality of times indicated by the operation plan, the simulation video by changing a state of the three-dimensional model at the time to a state based on the operation corresponding to the time.

14. The medium according to claim 11,
wherein the program causes the computer to further execute:
determining, for each of a plurality of periods, a target camera from among a plurality of the cameras, the target camera being a camera that is to acquire the real video in the period;
acquiring the real video generated by the target camera; and
generating, for each of the plurality of periods, the simulation video of the robot captured by the target camera in the period.

15. The medium according to claim 14,
wherein the program causes the computer to further execute:
acquiring camera plan information indicating the target camera for each of the plurality of periods;
acquiring, for each of the plurality of periods indicated by the camera plan information, the real video generated by the target camera associated with the period in the camera plan information; and
generating the simulation video of the robot captured by the target camera associated with the period in the camera plan information for each of the plurality of periods indicated by the camera plan information.
